(19) United States
(12) Patent Application Publication
(10) Pub. No.: US 2021/0342791 A1
(43) Pub. Date: Nov. 4, 2021

(54) MANUFACTURING SCHEDULES THAT INTEGRATE MAINTENANCE STRATEGIES

(71) Applicant: Siemens Aktiengesellschaft, Munich (DE)

(72) Inventors: Ioannis Akrotirianakis, Princeton, NJ (US); Amit Chakraborty, East Windsor, NJ (US)

(21) Appl. No.: 17/280,223

(22) PCT Filed: Sep. 28, 2018
(86) PCT No.: PCT/US2018/053396

§ 371 Date: Mar. 26, 2021

(51) Int. Cl. G06Q 10/00; G06Q 10/06

(52) U.S. Cl. CPC G06Q 10/20; G06Q 10/0637

(57) ABSTRACT

Systems, techniques, and computer-program products are provided to generate manufacturing schedules that integrate maintenance strategies. A manufacturing schedule can be generated by solving an optimization problem subject to operational constraints that preserve consistency in the order of the operations to be performed during the manufacture of a product, and further subject to maintenance constraints that enforce a desired maintenance strategy. The optimization problem can be solved by minimizing a makespan of a product subject to the operational and maintenance constraints.

### BACKGROUND

In the manufacturing industry it is common to employ a large number of machines that perform a variety of operations and produce different products. For example, in the metal processing industry, heavy fabrication is performed by different types of bending, rolling, and forming machines. These machines cut, deform, and weld cast iron, stainless steel, aluminum, nickel, steel and copper alloys, etc. Milling, drilling, and boring machines operate constantly under tight deadlines and therefore they have to be properly scheduled taking into consideration the customer demand as well as the health of the manufacturing equipment used.

Properly maintained equipment can reduce unexpected breakdowns which can cause long delays in the production process. This, in turn, may have significant effect in the on-time delivery of the products to the customers, as the specified deadlines may not be met.

### BRIEF DESCRIPTION OF THE DRAWINGS

The accompanying drawings are an integral part of the disclosure and are incorporated into the present specification. The drawings, which are not drawn to scale, illustrate example embodiments of the disclosure and, in conjunction with the description and claims, serve to explain at least in part various principles, features, or aspects of the disclosure. Some embodiments of the disclosure are described more fully below with reference to the accompanying drawings. However, various aspects of the disclosure can be implemented in many different forms and should not be construed as being limited to the implementations set forth herein. Like numbers refer to like, but not necessarily the same or identical, elements throughout.

FIG. 1 presents an example of a computing system to generate manufacturing schedules that integrate maintenance strategies, in accordance with one or more embodiments of the disclosure.

FIG. 2 presents an example of a sequence of operations required to complete a product, in accordance with one or more embodiments of the disclosure.

FIG. 3 presents an example of an activity diagram for machines that manufacture a product, in accordance with one or more embodiments of the disclosure.

FIG. 4 presents another example of an activity diagram for machines that manufacture a product, in accordance with one or more embodiments of the disclosure.

FIG. 5 illustrates a branch-and-bound diagram of an example process for solving an optimization problem to generate a manufacturing schedule that integrates a maintenance strategy, in accordance with one or more embodiments.

FIG. 6 presents an example of a method for generating a manufacturing schedule that integrates a maintenance strategy in accordance with one or more embodiments of the disclosure.

FIG. 7 presents an example of an operational environment in which generation of manufacturing schedules can be implemented in accordance with one or more embodiments of the disclosure.

### DETAILED DESCRIPTION

The disclosure recognizes and addresses, in at least some embodiments, the issue of scheduling manufacturing machines. Accordingly, the disclosure provides technologies to generate manufacturing schedules that integrate maintenance planning decisions and/or quality assurance decisions within a manufacturing process. Embodiments of the disclosure include systems, techniques, and computer-program products that, individually or in combination, permit generating manufacturing schedules that account for a desired maintenance strategy. As is described in greater detail below, a manufacturing schedule can be generated by solving an optimization problem subject to operational constraints that preserve consistency in the order of the operations to be performed during the manufacture of a product, and further subject to maintenance constraints that enforce a desired maintenance strategy. The optimization problem can be solved by minimizing a makespan of a product subject to the operational and maintenance constraints. A mathematical optimization model that integrates maintenance decisions and/or quality assurance decisions within a manufacturing process can permit specifying such constraints. Quality constraints may include a decision to repeat a defined operation or perform the defined operation for additional time in response to determining a resulting product or an outcome of the operation does not satisfy defined quality requirement(s). For example, the polishing of a metallic surface may not satisfy a quality requirement or another type of quality fulfillment criterion. Therefore, the metallic surface can be returned to the appropriate machine for further work.

Embodiments of this disclosure can provide numerous technical improvements and benefits over conventional technologies for manufacturing scheduling. For example, in sharp contrast to conventional manufacturing scheduling approaches, by generating a manufacturing schedule subject at least to maintenance constraints, embodiments of this disclosure generate manufacturing schedules that can mitigate unexpected breakdowns and can reduce operating cost of machines. Therefore, embodiments of the disclosure can improve the likelihood of meeting customer demand in agreed deadlines, thus increasing customer satisfaction. As another example, embodiments of the disclosure can permit properly maintaining a set of machines while achieving a desired throughput. As such, by Incorporating maintenance planning into a production schedule, embodiments of the disclosure permit or otherwise facilitate increasing operational efficiency and reducing energy consumption. As yet another example, embodiments of the disclosure can readily incorporate constraints that can increase yield by mitigating (or, in some instances, avoiding altogether) the occurrence of imperfection or defects during the manufacture of a product. More specifically, in a manufacturing station or factory floor, a machine that is not properly maintained is more prone to producing unsatisfactory products—e.g., products having a number and/or types of defects that exceed prescribed tolerances; products that exceed a desired or intended cost target, or the like. Accordingly, by generating a manufacturing schedule that incorporates a maintenance plan directed to maintaining a machine at appropriate times (e.g., when certain defects arise on the products they operate on) the occurrence of imperfections in resulting products can be reduced.

While embodiments of this disclosure are illustrated with reference to maintenance that is performed periodically, the disclosure is not limited in that respect. The principles and practical elements of this disclosure can be applied, with modifications, to other maintenance strategies. For example, in some scenarios, a maintenance strategy can include the dynamic implementation of maintenance decisions; e.g., maintenance is performed dynamically, in response to data and/or other types of observed conditions. Specifically, yet not exclusively, maintenance can be performed in response to presence of certain defects on specific products. A human operator or a camera that monitors quality of resulting products can determine the presence of such defects.

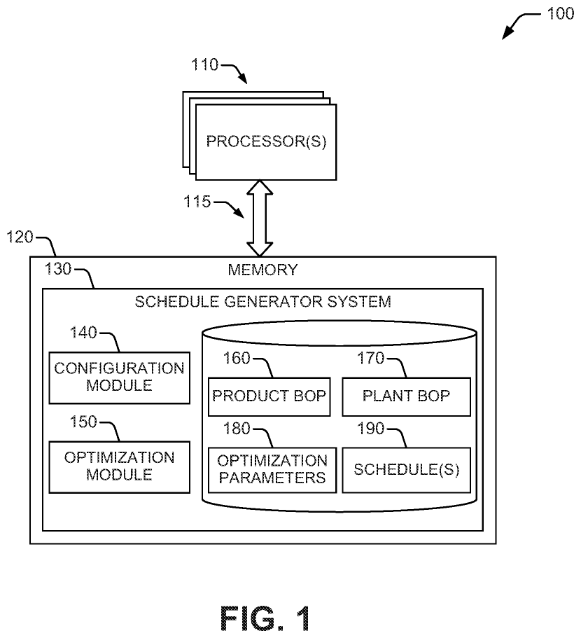

With reference to the drawings, FIG. 1 presents an example of a computing system 100 to generate a manufacturing schedule that integrates maintenance planning, in accordance with one or more embodiments of the disclosure. The illustrated computing system 100 includes one or more processor(s) 110 and one or more memory devices 120 (generically referred to as memory 120) that include machine-accessible instructions (e.g., computer-readable and/or computer-executable instructions) that can be accessed and executed by at least one of the processor(s) 110. In one example, the processor(s) 110 can be embodied in or can constitute a graphics processing unit (GPU), a plurality of GPUs, a central processing unit (CPU), a plurality of CPUs, an application-specific integrated circuit (ASIC), a microcontroller, a programmable logic controller (PLC), a field programmable gate array (FPGA), a combination thereof, or the like. In some embodiments, the processor(s) 110 can be arranged in a single computing apparatus (e.g., a blade server). In other embodiments, the processor(s) 110 can be distributed across two or more computing apparatus.

The processor(s) 110 can be functionally coupled to the memory 120 by means of a communication architecture 115. The communication architecture 115 is suitable for the particular arrangement (localized or distributed) of the processor(s) 110. As such, the communication architecture 115 can include base station devices; router devices; switch devices; server devices; aggregator devices; bus architectures; a combination of the foregoing; or the like.

The memory 120 includes a schedule generator system 130. The schedule generator system 130 includes machine-accessible instructions (e.g., computer-readable and/or computer-executable instructions) that embody or constitute the schedule generator system 130. The instructions are encoded in the memory 120 and can be arranged in components that can be built (e.g., linked and compiled) and retained in computer-executable form in the memory 120 (as is shown) or in one or more other machine-accessible non-transitory storage media.

As such, the instructions can be arranged in modules, including a configuration module 140 and an optimization module 150. The schedule generator system 130 also includes numerous data structures. The machine-accessible instructions that form the schedule generator system 130 can be executed by at least one processor of the processor(s) 110. It is noted that while not illustrated, the computing system 100 also can include other types of computing resources (e.g., controller devices(s), power supplies, and the like) that can permit or otherwise facilitate the execution of the schedule generator system 130. Execution of the instructions can cause the at least one processor—and, thus, the computing system 100—to determine a manufacturing schedule that integrates maintenance planning decisions, in accordance with aspects of this disclosure.

The standard manufacturing optimization problem can be modeled as the classical job shop scheduling problem. In such a setting there are a number of products p (a natural number) to me manufactured, and a number of machines M (a natural number) that can perform a sequence of operations included in a process to manufacture a product. For each product j (or, alternatively, a job) a number operations nⱼ (a natural number) can be included in the process that is performed to manufacture the final product j. Such operations can be referred to as the operations of product j and can be represented by a set Oⱼ that includes individual operations oᵢⱼ, where i=1, 2, . . . nⱼ. Namely, Oⱼ={o₁ⱼ, o₂ⱼ, . . . , oₙⱼ_{^{j}}}. The processing time needed for operation oᵢⱼ can be represented as pᵢⱼ.

The computing system 100 includes a one or more data structures 160 (generically referred to as product bill of process (BOP) 160) that includes information indicative of the set of operations Oⱼ. The product BOP also can include other information indicative of components and subassemblies that constitute the product j and resources needed to build the product j. One of resources can include processing time to be allocated for an operation included in the process to manufacture a product. As such, the product BOP 160 also includes information indicative or otherwise representative of processing time pᵢⱼ for each operation operation oᵢⱼ. The computing system 100 also includes a one or more data structures 170 (generically referred to as plant BOP 170) that includes information indicative of the M machines that can manufacture the product j. The plant BOP 170 also includes information indicative of the capabilities (or skills) of each one of the machines M A list of the operations that can be performed at a defined machine also can be included.

The computing system 100 can receive the data, metadata, and/or other type of information included in the product BOP 160 and the plant BOP 170 from a source device (not depicted in FIG. 1). The source device can be functionally coupled to the computing system 100 and can be embodied in or can include a network apparatus (e.g., a server device and a gateway device). Such data, metadata, and other information can be received wirelessly or via a wireline connection. In addition, or in another embodiment, the source device can be embodied in or can include a storage device that can be coupled to the computing system 100, for example, via an input interface device or network adapter device.

In some embodiments, each one of the M machines can process a single operation of a specific product (or job) at a time. In addition, each operation of the set Oⱼ cannot be interrupted after the operation has started on a machine. The completion time interval of a product j is represented by cⱼ, and the completion of operation i of job j is represented as cᵢⱼ. Therefore, the completion time of product j is the completion time of the last operation oₙⱼ_{^{j}} of the job j; namely, cⱼ=cₙⱼ_{^{j}}.

As an illustration, in a molding job shop, a manufacturing company can manufacture different molds for products, such as head lamp reflectors used in the car industry. A mold can include the following jobs: a core, a cavity, slides, a retractor, and clamp plates. Each of those jobs can include a combination of the following molding operations: (a) roughing, (b) semi-finishing, (c) stress relieving, (d) finishing, (e) boring, (f) gun drilling, (g) carbon processing, (h) electro-discharge machining, and (i) mold assembly. More specifically, the foregoing molding operations (a) to (i) are performed to produce cavities and cores. Production of mold slides rely on operations (a), (d), (g), and (h). Production of retractors rely on operations (a) and (d). Production of clamp plates rely on (e).

The molding job shop has machines that can perform one or more of the molding operations (a) to (i). The number and type(s) of operations that each one of the machines can perform is determined by capabilities (or skills) of the machine. For instance, one of the machines can perform roughing only, whereas another one of the machines can perform roughing and carbon processing. The plant BOP 170 can include, in some embodiments, information indicative of such machines and the capabilities of the machines.

The process to manufacture the product/ can include a parameter rᵢⱼ (e.g., a natural number) indicative of a number of times the operation oᵢⱼ is performed during the execution of the process to manufacture the product j. The parameter rᵢⱼ can be defined as part of the process for manufacturing the product j. For instance, a molding job shop, the process can specify a sequence of operations including roughing, gun drilling, boring, and then roughing again. Thus, the parameter rᵢⱼ can be included in a product BOP for product j. As mentioned, the product BOP specifies a sequence of operations required or otherwise configured to be performed in order to complete the manufacture of product j. As such, information indicative of the parameters rᵢⱼ for the set of operations can included in the product BOP 160. It is noted that while a sequence of operations can include a predetermined number of repetitions of a specific operation, the schedule generator system 130 can determine the scheduling of such operations (e.g., the starting times of each of these operations) by solving an optimization problem subject to the constraints disclosed herein. To that end, at least one of the processor(s) 110 can execute the optimization module 150 to solve the optimization problem subject to such constraints. Solving the optimization problem can include determining a manufacturing schedule that minimizes a makespan Cₘₐₓ (a real number in units of time) relative to other manufacturing schedules.

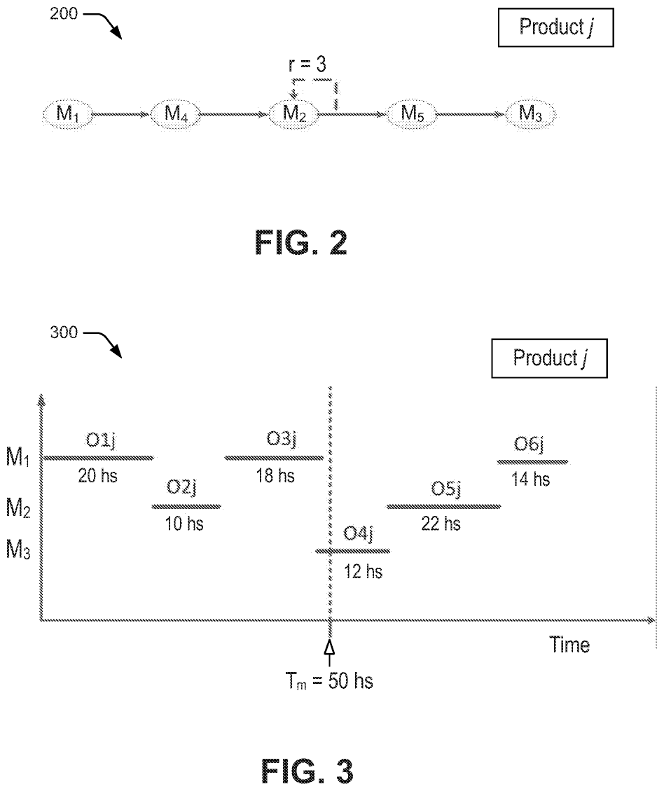

It is common in the classical job shop approach to a scheduling problem to have the operations of a job performed one time. In contrast, this disclosure is not so limited and, in some embodiments, an operation of a process to manufacture a product can be performed multiple times. In such embodiments, the processing time pᵢⱼ of operation oᵢⱼ is equal to the number of times the operation oᵢⱼ is performed. The completion time of the product j increases accordingly. As an illustration, FIG. 2 presents an example sequence of operations 200 required to complete a product j (or job j), in accordance with one or more embodiments of the disclosure. Five different machines M₁, M₂, M₃, M₄, and M₅ can implement the sequence of operations and can collectively manufacture the product j. In the sequence, the operation performed by machine M₂ occurs 3 times, and thus, it is depicted as having a repetition factor r=3.

In some aspects, the manufacturing schedule for a product j is characterized by a combination of a first set of binary decision parameters {xᵢⱼₜ} and a second set of binary decision parameters {yᵢⱼₜ}. Here, xᵢⱼₜ=1 in a scenario in which operation i of the product j is processed at the start of an interval t, and xᵢⱼₜ=0 otherwise. As such, binary decision parameters {xᵢⱼₜ} can determine when different operations on the different machines are implemented. In addition, yᵢⱼₜ=1 in a scenario in which operation i of the job j is processed at the end of the interval t, and yᵢⱼₜ=0 otherwise. Accordingly, binary decision parameters {yᵢⱼₜ} can determine an ordering of maintenance events for the different machines, consistently with scheduled operations on the machines.

Therefore, as mentioned, to determine a manufacturing schedule that integrates maintenance planning decisions, the schedule generator system 130 can solve an optimization problem with respect to Cₘₐₓ, subject to various constraints. Specifically, solving the optimization problem can include minimizing Cₘₐₓ subject to first constraints that preserve consistency in the order of the operations to be performed during the manufacture of a product and further subject to second constraints that enforce a defined maintenance strategy.

Numerous strategies can be implemented for performing maintenance (e.g., diagnosing and/or repairing equipment) in a manufacturing plant. One example strategy includes periodic maintenance, where each machine in the manufacturing facility is removed from the production line after completing a defined number of operating hours. A second strategy includes preventive maintenance. Such a strategy can be based at least on machine reliability measures or other types of machine performance indicators. As such, sensor devices can be integrated into or otherwise can be coupled to a machine to monitor operating states of respective vital components of the machine. The operational states can be monitored in nearly real time, at defined instants, or in response to specific events. Regardless of the type of monitoring, in response to detecting an abnormality in an operating state, a signal can be generated to decommission the machine and perform one or more defined maintenance tasks.

As mentioned, while some embodiments of this disclosure are illustrated with reference to periodic maintenance, the disclosure is not so limited and other types of maintenance strategies can be contemplated. More specifically, maintenance strategies that include executing maintenance dynamically also can be implemented. To that end, an optimization model in accordance with this disclosure can be updated (e.g., initially configured or changed after an initial configuration) by including constraints that describe one or more maintenance tasks to be performed in a corresponding machine, in response to a defined criterion for maintenance execution being satisfied. Accordingly, the optimization model can be dynamically updated.

Maintenance tasks span respective times and after completion, the machine can be utilized again in a production process. In embodiments in which multiple maintenance tasks can implemented in machine Mᵢ, the time spanned by a maintenance task k in machine Mᵢ can be represented as μᵢ. In an embodiment in which a single maintenance task can be implemented in the machine Mᵢ, the time spanned by the maintenance task can be represented as μᵢ. Aspects of the disclosure are illustrated for scenarios in which a single maintenance task can be implement. The disclosure, however, is not limited in that respect and in scenarios in which multiple maintenance tasks can be implanted in a machine, the principles of the disclosure still can be applied after including additional maintenance constraints to account for different maintenance tasks.

As mentioned, to integrate predictive maintenance planning into manufacturing scheduling, the schedule generator system 130 generates the manufacturing schedule subject to several constraints. Causality. A first group of constraints corresponds to causality—a current operation in a process for manufacturing a product cannot complete after a subsequent operation begins. In formal terms, for operations oᵢⱼ and oᵢ₊₁ⱼ in the process for manufacturing a product j, the following constraints are to be satisfied:

tᵢⱼ+rᵢⱼpᵢⱼ≤t_{i+1,j} (1)

where tᵢⱼ (a real number in units of time) represents the starting time of operation oᵢⱼ (the starting time of operation i of the process for manufacturing product j) and t_{i+i,j} represents the starting time of operation oᵢ₊₁ⱼ. As mentioned, in contrast to conventional scheduling approaches, the disclosure incorporates a group of reiteration parameters rᵢⱼ of operation oᵢⱼ, where rᵢⱼ≥1. A reiteration parameter rᵢⱼ accounts for the number of times operation i is performed during the manufacturing of the product j. For instance, as is illustrated in FIG. 2, for rᵢⱼ=3, operation i is performed three times and the total processing time is 3×pᵢⱼ. Therefore, the constraint in Eq. (1) models the fact that the completion time of operation i of job j (e.g., tᵢⱼ+rᵢⱼpᵢⱼ) cannot be after the starting time of the next operation i+1 of the same job j (e.g., t_{i+1,j}).

Maintenance compliance. A second group of constraints corresponds to maintenance compliance. An operation that is configured to be performed by a machine that is subjected to maintenance has to be arranged for execution after completion of a maintenance event. In addition, as mentioned, a machine can process a single operation at a time during the manufacture of a product. Thus, a machine that performs an operation oᵢⱼ of a process to manufacture a product j can be labeled with the index i and can be referred to as machine i. Therefore, in a scenario in which the machine i requires maintenance periodically, at intervals T= [symbol] t, and is decommissioned for an interval μᵢΔt the following constraints are to be satisfied:

$${\sum }_{t = 1}^{ℓ} {x}_{ijt} + {y}_{i , ℓ + 1} {μ}_{i} \leq {t}_{i + 1 , j} . \qquad ( 2 )$$

Here, [symbol] and τ are natural numbers and Δt (a real number in units of time) represents a defined reference period (e.g., one hour, one day, one week, one month, or the like). Such a constraint ensures that the operation oᵢⱼ performed by the machine i during the manufacture of the product j is performed after maintenance of the machine i has been completed.

Generic ranges for τ and/or μᵢ, respectively, are specific to a machine. There are machines that can be maintained in a few hours and others that required to be decommissioned for 1 to 2 days. In some embodiments, maintenance duration can range from about one hour to a few hours.

Maintenance assurance. The following constraint ensures that a machine undergoes a maintenance event periodically, every [symbol] time periods.

$${\sum }_{t = 1}^{{ℓ}^{′}} {x}_{ijt} \leq ℓ , \qquad ( 3 )$$

where [symbol] ≥ [symbol] . The latter condition ensures that the machine i may not be in operation at every time, e.g., the machine may not be included in the product BOP 160 for some products. Hence, the machine Mᵢ need not undergo maintenance strictly at [symbol] time intervals, being able to remain without maintenance for a longer time interval [symbol] .

With further reference to FIG.1, the illustrated computing system 100 includes a configuration module 140 that can configure the foregoing constraints. Specifically, at least one of the processors 110 can execute the configuration module 140 to configure such constraints for each realization of the binary decision values {xⱼₜ} and {yᵢⱼₜ}, while the optimization problem that yield a manufacturing schedule is being solved.

As mentioned a strategy usually implemented to maintain (e.g., diagnose and/or repair) equipment in an industrial environment. A first strategy utilizes “wall clock time.” That is, a machine undergoes maintenance after a defined time interval T has elapsed from the beginning of a scheduling horizon, regardless the amount of time that the machine has been active (or in operation) during the interval Tₘ. For instance, such time interval can be a defined number of hours within a calendar day or a defined number of hours that correspond to a number of calendar days. In such a case, the machine undergoes maintenance after a fixed number of hours has passed.

Such a strategy can result in one or more machines in a plant or factory being maintained more often that needed, causing additional operational expenses. As an example, FIG. 3 illustrates a diagram 300 of activity of different machines M₁, M₂, and M₃ that collectively manufacture a product j. The activity is shown in a timeline (labeled “Time”) of wall-clock time; the abscissa in FIG. 3. A maintenance wall clock time Tm equal to 50 hours is associated with one of the machines (e.g., Mᵢ). The maintenance wall-clock time Tₘ=50 hs does not represent a time during which M₁ has been operating. Instead, as mentioned, wall-clock time represents time that has elapsed since a job to manufacture product j started. Again, three machines and Tₘ=50 hs serve simply as examples, and the principles and practical elements of the disclosure are not limited in those respects. A dashed line indicates the instant at which Tₘ=50 hours have elapsed from the beginning of scheduling horizon.

The illustrated process to manufacture a product j consists of six operations {o₁ⱼ, o₂ⱼ, o₃ⱼ, o₄ⱼ, o₅ⱼ, o₆ⱼ} to be performed, as stated, by three different machines M₁, M₂ and M₃. In FIG. 3, for each one of the six operations, the processing time by the corresponding machine is shown. The process to manufacture the product j can dictate that machines M₁, M₂, and M₃ are visited (or otherwise engaged in the process) in the following order: (M₁, M₂, M₁, M₃, M₂, M₁). As is illustrated in FIG. 3, machine M₁ is the most active (longest time in operation), machine M₂ is the second most active, and machine M₃ is the least active.

In a scenario in which machine M₁ undergoes maintenance after the maintenance wall clock Tₘ of 50 hours, maintenance is ordered for machine M₁ at about the time indicted by the dashed line in FIG. 3. Yet, machine M₁ has been active or otherwise operational for 38 hours, processing operations o₁ⱼand o₃ⱼ. Therefore, machine M₁ is overmantained (e.g., maintained more often that needed) which can causes unnecessary additional expenses to a plant owner or administrator.

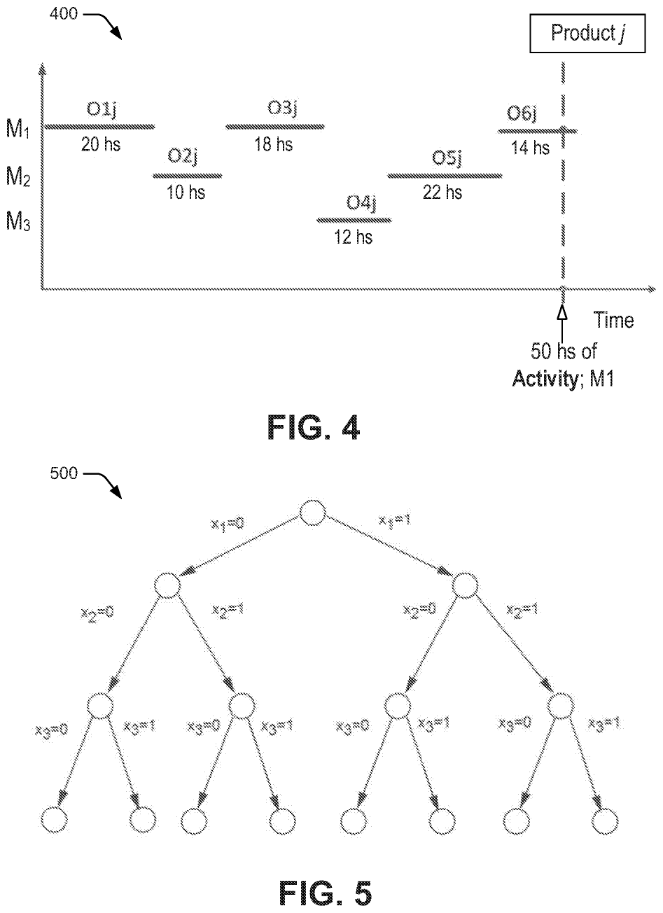

In sharp contrast to the foregoing example scenario provided by commonplace maintenance strategies that are typically adopted in conventional scheduling strategies, the schedule generator system 130 permits generating a manufacturing schedule that avoids unnecessary maintenance of a machine, therefore improving commonplace scheduling technologies. Specifically, with continued reference to the foregoing example scenario, by generating a manufacturing schedule subject to the maintenance compliance constraint in Eq. (2) and the maintenance assurance constraint in Eq. (3), the schedule generator system 130 can permit the scheduling of the operations {o₁ⱼ, o₂ⱼ, o₃ⱼ, o₄ⱼ, o₅ⱼ, o₆ⱼ} in a manner that maintenance for the machine M₁ is performed when the machine M₁ completes 50 hours of activity (or operating time). FIG. 4 illustrates as much, depicting (with a dashed line) the instant at which 50 operational hours (or hours of activity) have been completed while manufacturing the product j. Such an instant is, of course, different from the instant at which 50 wall-clock hours from the beginning of the scheduling horizon have elapsed. At about such an instant, the machine M₁ can be decommissioned and can undergo maintenance. Therefore, avoiding a maintenance event prior to the machine M₁ having been active for a planned maintenance period of 50 hours. Accordingly, M1 is not overmaintained, as discussed above in connection with FIG. 3.

In addition, as is illustrated in FIG. 4, machine M₁ can be decommissioned for maintenance after operation o₆ⱼ, without causing M₁ to be substantially undermaintained (e.g., maintained less than planned or otherwise desired). Indeed, in the example illustrated in FIG. 4, M1 can be maintained at about 52 hours of activity, the time resulting from execution of oiⱼ, o₃ⱼ, and o₆ⱼ.The strategy can be generalized for all three machines, ensuring that each one of the machines is maintained upon or after the machine has operated for a period equal to T (50 hours in this example).

FIG. 5 illustrates a branch-and-bound diagram 500 that depicts an example process to solve an optimization problem to generate a manufacturing schedule that integrates maintenance planning, in accordance with one or more embodiments of the disclosure. The branch-and-bound diagram has the form of a binary tree. Each node in the binary tree represents a continuous relaxation of the optimization problem that results from the original scheduling problem. As mentioned, the scheduling problem includes determining a first set of binary decision parameters {xᵢⱼₜ} and a second set of binary decision parameters {yᵢⱼₜ} that satisfies the causality constraints (Eq. (1)), the maintenance compliance constraints (Eq. (2)), and the maintenance assurance constraints (Eq. (3)).

The continuous relaxation allows the binary decision variables {xᵢⱼₜ} and {yᵢⱼₜ} to take continuous values. A solution of the continuous relaxation model is a lower bound of the original scheduling problem that is intended to be solved. The optimization module 136 can determine a solution of the continuous relaxation and round the determined continuous values that correspond to the variables {xᵢⱼₜ} and {yᵢⱼₜ} to binary values.

More specifically, at the root node in the branch-and-bound diagram 500, all {xᵢⱼₜ} and {yᵢⱼₜ} are relaxed to take continuous values. The optimization module 136 can configure a first binary decision variable to 0 and 1, thus spawning two branches, and can permit all other binary variables to take continuous values. The optimization module 136 can solve the resulting two optimization problems: a first optimization problem for the “0” branch and a second optimization problem for the “1” branch. After a solution is determined, the optimization module 136 can fix a next binary variable to 0 and 1, spawning four branches, each corresponding to a new optimization problem. The optimization module 136 can solve the resulting four optimization problems and can generate another set of optimization problems, which in turn can be solved. The optimization module 136 can continue the example process continues until the optimization module 136 has configured all binary decision variables {xᵢⱼₜ} and {yᵢⱼₜ} to have 0 or 1 values.

As such, a node of the binary tree can represent a solution that has all binary decision variables fixed to 0 or 1. Such a solution is referred to as an incumbent solution and serves as an upper bound of the original scheduling problem. Again, the original scheduling problem corresponding to determining a first set of binary decision parameters {xᵢⱼₜ} and a second set of binary decision parameters {yᵢⱼₜ} that satisfies the causality constraints (Eq. (1)), the maintenance compliance constraints (Eq. (2)), and the maintenance assurance constraints (Eq. (3)).

The optimization module 136 can utilize the value of the incumbent solution to fathom (or prune) parts of the binary tree. Specifically, when a node (e.g., a continuous relaxation) has a binary value that is larger than the incumbent solution, the optimization module 136 can fathom the entire subtree that originates from such a node. Therefore, the optimization module 136 can avoid an exhaustive search of the binary tree (e.g., solve all the possible combinations of values) and find the optimal binary solution faster. Thus, generating a suitable manufacturing schedule that integrates maintenance planning.

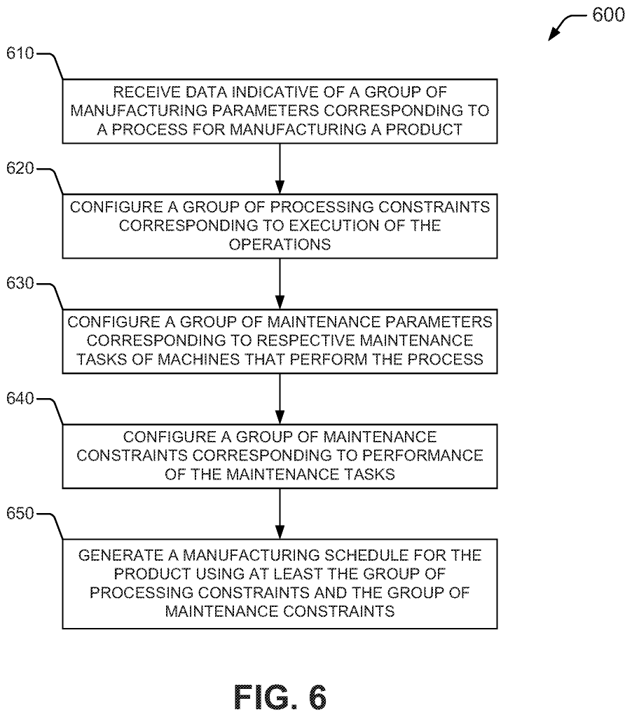

In view of various aspects described herein, examples of methods that can be implemented in accordance with this disclosure can be better appreciated with reference to FIG. 6. For purposes of simplicity of explanation, the exemplified methods (and other techniques disclosed herein) are presented and described as a series of operations. It is noted, however, that the exemplified methods and any other techniques of this disclosure are not limited by the order of operations. Some operations may occur in different order than that which is illustrated and described herein. In addition, or in the alternative, some operations can be performed essentially concurrently with other operations (illustrated or otherwise). Further, not all illustrated operations may be required to implement an exemplified method or technique in accordance with this disclosure. Furthermore, in some embodiments, two or more of the exemplified methods and/or other techniques disclosed herein can be implemented in combination with one another to accomplish one or more elements and/or technical improvements disclosed herein.

In some embodiments, one or several of the exemplified methods and/or other techniques disclosed herein can be represented as a series of interrelated states or events, such as in a state-machine diagram. Other representations also are possible. For example, interaction diagram(s) can represent an exemplified method and/or a technique in accordance with this disclosure in scenarios in which different entities perform different portions of the disclosed methodologies.

It should be further appreciated that the example methods disclosed in this specification can be retained or otherwise stored on an article of manufacture (such as a computer-program product) in order to permit or otherwise facilitate transporting and transferring such example methods to computers for execution, and thus implementation, by processor(s) or for storage in a memory.

Methods disclosed throughout the subject specification and annexed drawings are capable of being stored on an article of manufacture to facilitate transporting and transferring such methodologies to computers or other types of information processing machines or processing circuitry for execution, and thus implementation by a processor or for storage in a memory device or another type of computer-readable storage device. In one example, one or more processors that perform a method or combination of methods disclosed herein can be utilized to execute programming code instructions retained in a memory device or any computer-readable or machine-readable storage device or non-transitory storage media, to implement one or several of the exemplified methods and/or other techniques disclosed herein. The programming code instructions, when executed by the one or more processors can implement or carry out the various operations in the exemplified methods and/or other technique disclosed herein.

The programming code instructions, therefore, provide a computer-executable or machine-executable framework to implement the exemplified methods and/or other techniques disclosed herein. More specifically, yet not exclusively, each block of the flowchart illustrations and/or combinations of blocks in the flowchart illustrations can be implemented by the programming code instructions.

FIG. 6 presents a flowchart of an example method 600 for generating manufacturing schedules that integrate respective maintenance strategies, in accordance with one or more embodiments of the disclosure. The example method 600 can be implemented, entirely or in part, by a computing system having one or more processors, one or more memory devices, and/or other types of computing resources. In some embodiments, the computing system can embody or can include the schedule generator system 100.

At block 610, the computing system can receive data indicative of a group of manufacturing parameters corresponding to a process for manufacturing a product. As mentioned, in one embodiment, the product can be a constituent part of another product. In another embodiment, the product can be embodied in a finished product that results from processing one or more constituent parts. Regardless of the type of product, the process includes operations that can be executed by a group of machines to manufacture the product.

At block 620, the computing system can configure a group of processing constraints corresponding to the execution of the operations. For example, the group of processing constraints include the causality constraints disclosed herein (see, e.g., Eq. (1) hereinbefore). At block 630, the computing system can configure a group of maintenance parameters corresponding to respective maintenance tasks applied to at least one of the group of machines. For example, the computing system can configure the periodicity T= [symbol] Δt of maintenance events and a group of time intervals {μᵢΔt} that a defined machine i of the group of machines is decommissioned to perform maintenance of such machine.

At block 640, the computing system can configure a group of maintenance constraints corresponding to performance of the maintenance tasks. For example, the group of maintenance constraints can include the maintenance compliance constraints, and/or the maintenance assurance constraints disclosed herein (see, e.g., Eq. (2) and Eq. (3) hereinbefore).

At block 650, the computing system can generate a manufacturing schedule for the product using at least the group of processing constraints and the group of maintenance constraints. As is disclosed herein, in some embodiments, the manufacturing schedule can be generated by solving an optimization problem with respect to a makespan of the product and subject to the group of processing constraints and the group of maintenance constraints.

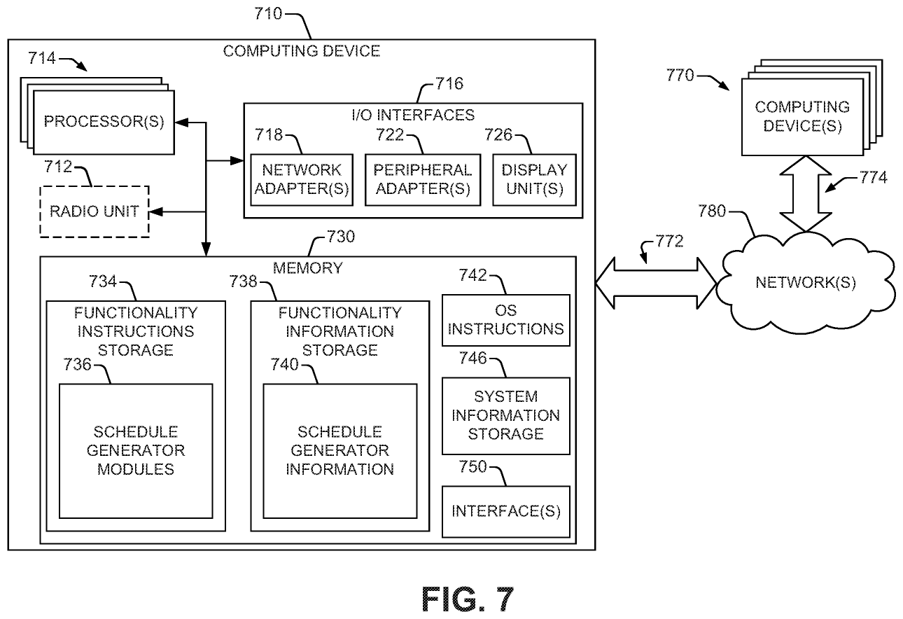

FIG. 7 presents an example of a computational environment in which manufacturing schedules that integrate a maintenance strategy can be generated in accordance with one or more embodiments of the disclosure. The exemplified operational environment 700 is merely illustrative and is not intended to suggest or otherwise convey any limitation as to the scope of use or functionality of the operational environment's architecture. In addition, the exemplified operational environment 700 depicted in FIG. 7 should not be interpreted as having any dependency or requirement relating to any one or combination of modules or other types of components illustrated in other example operational environments of this disclosure.

The example operational environment 700 or portions thereof can embody or can constitute other ones of the various operational environments and systems described hereinbefore. As such, the computing device 710, individually or combination with at least one of the computing device(s) 770), can embody or can constitute the computing system 100 described herein.

The computational environment 700 represents an example implementation of the various aspects or elements of the disclosure in which the processing or execution of operations described in connection with generation of manufacturing schedules that integrate maintenance strategies in accordance with aspects disclosed herein can be performed in response to execution of one or more software components at the computing device 710. Such one or more software components render the computing device 710 (or any other computing device that contains the software component(s) a particular machine for generating manufacturing schedules that integrate maintenance strategies, in accordance with aspects described herein, among other functional purposes.

A software component can be embodied in or can include one or more computer-accessible instructions (e.g., computer-readable and/or computer-executable instructions). In some embodiments, as mentioned, at least a portion of the computer-accessible instructions can be executed to perform at least a part of one or more of the example methods (e.g., method 600) and/or other techniques described herein.

For instance, to embody one such method, at least the portion of the computer-accessible instructions can be retained in a computer-readable storage non-transitory medium and executed by one or more processors (e.g., at least one of processor(s) 714). The one or more computer-accessible instructions that embody or otherwise constitute a software component can be assembled into one or more program modules, for example. Such program module(s) can be compiled, linked, and/or executed (by one or more of the processor(s) 714) at the computing device 710 or other computing devices.

Further, such program module(s) can include computer code, routines, programs, objects, components, information structures (e.g., data structures and/or metadata structures), etc., that can perform particular tasks (e.g., one or more operations) in response to execution by one or more processors. At least one of such processor(s) can be integrated into the computing device 710. For instance, the one or more processor that can execute the program module(s) can be embodied in or can include a non-empty subset the processor(s) 714. In addition, at least another one of the processor(s) can be functionally coupled to the computing device 710.

The various example embodiments of the disclosure can be operational with numerous other general purpose or special purpose computing system environments or configurations. Examples of well-known computing systems, environments, and/or configurations that can be suitable for implementation of various aspects or elements of the disclosure in connection with generation of manufacturing schedules in accordance with aspects of this disclosure can include personal computers; server computers; laptop devices; handheld computing devices, such as mobile tablets or e-readers; wearable computing devices; and multiprocessor systems. Additional examples can include, programmable consumer electronics, network personal computers (PCs), minicomputers, mainframe computers, blade computers, programmable logic controllers, distributed computing environments that comprise any of the above systems or devices, and the like.

As is illustrated in FIG. 7, the computing device 710 includes one or more processors 714, one or more input/output (I/O) interfaces 716; one or more memory devices 730 (collectively referred to as memory 730); and a bus architecture 732 (also termed bus 732). The bus architecture 732 functionally couples various functional elements of the computing device 710. The bus 732 can include at least one of a system bus, a memory bus, an address bus, or a message bus, and can permit or otherwise facilitate the exchange of information (data, metadata, and/or signaling) between the processor(s) 714, the I/O interface(s) 716, and/or the memory 730, or respective functional elements therein. In some scenarios, the bus 732 in conjunction with one or more internal programming interfaces 750 (collectively referred to as interface(s) 750) can permit or otherwise facilitate such exchange of information. In scenarios in which the processor(s) 714 include multiple processors, the computing device 710 can utilize parallel computing.

In some embodiments, the computing device 710 can include, optionally, a radio unit 712. The radio unit 712 can include one or more antennas and a communication processing unit that can permit wireless communication between the computing device 710 and another device, such as one of the computing device(s) 770 or a sensor device.

The I/O interface(s) 716 can permit or otherwise facilitate communication of information between the computing device 710 and an external device, such as another computing device (e.g., a network element or an end-user device) or a sensor device. Such communication can include direct communication or indirect communication, such as the exchange of information between the computing device 710 and the external device via a network or elements thereof. In some embodiments, as is illustrated in FIG. 7, the I/O interface(s) 716 can include one or more of network adapter(s) 718, peripheral adapter(s) 722, and display unit(s) 726. Such adapter(s) can permit or otherwise facilitate connectivity between the external device and one or more of the processor(s) 714 or the memory 730. For example, the peripheral adapter(s) 722 can include a group of ports, which can include at least one of parallel ports, serial ports, Ethernet ports, V.35 ports, or X.21 ports. In certain embodiments, the parallel ports can comprise General Purpose Interface Bus (GPIB), IEEE-1284, while the serial ports can include Recommended Standard (RS)-232, V.11, Universal Serial Bus (USB), FireWire or IEEE-1394.

At least one of the network adapter(s) 718 can functionally couple the computing device 710 to one or more computing devices 770 via one or more communication links (wireless, wireline, or a combination thereof) and one or more networks 780 that, individually or in combination, can permit or otherwise facilitate the exchange of information (data, metadata, and/or signaling) between the computing device 710 and the one or more computing devices 770. Such network coupling provided at least in part by the at least one of the network adapter(s) 718 can be implemented in a wired environment, a wireless environment, or both. The network(s) 780 can include several types of network elements, including base stations; router devices; switch devices; server devices; aggregator devices; bus architectures; a combination of the foregoing; or the like. The network elements can be assembled to form a local area network (LAN), a metropolitan area network (MAN), a wide area network (WAN), and/or other networks (wireless or wired) having different footprints.

Information that is communicated by at least one of the network adapter(s) 718 can result from the implementation of one or more operations of a method (or technique) in accordance with aspects of this disclosure. Such output can be any form of visual representation, including textual, graphical, animation, audio, haptic, and the like. In some scenarios, each one of the computing device(s) 770 can have substantially the same architecture as the computing device 710. In addition or in the alternative, the display unit(s) 726 can include functional elements (e.g., lights, such as light-emitting diodes; a display, such as a liquid crystal display (LCD), a plasma monitor, a light-emitting diode (LED) monitor, or an electrochromic monitor; combinations thereof; or the like) that can permit or otherwise facilitate control of the operation of the computing device 710, or can permit conveying or revealing the operational conditions of the computing device 710.

In one aspect, the bus architecture 732 represents one or more of several possible types of bus structures, including a memory bus or a memory controller, a peripheral bus, an accelerated graphics port, and a processor or local bus using any of a variety of bus architectures. As an illustration, such architectures can include an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), and the like.

The bus architecture 732, and all other bus architectures described herein can be implemented over a wired or wireless network connection and each of the subsystems, including the processor(s) 714, the memory 730 and memory elements therein, and the I/O interface(s) 716 can be contained within one or more remote computing devices 770 at physically separate locations, connected through buses of this form, in effect implementing a fully distributed system.

In some embodiments, such a distributed system can implement the functionality described herein in a client-host or client-server configuration in which the schedule generator modules 736 or the schedule generator information 740, or both, can be distributed between the computing device 710 and at least one of the computing device(s) 770, and the computing device 710 and at least one of the computing device(s) 770 can execute such modules and/or leverage such information.

The computing device 710 can include a variety of computer-readable media. Computer-readable media can be any available media (transitory and non-transitory) that can be accessed by the computing device 710. In one aspect, computer-readable media can include computer non-transitory storage media (or computer-readable non-transitory storage media) and communications media. Example computer-readable non-transitory storage media can include, for example, both volatile media and non-volatile media, and removable and/or non-removable media. In one aspect, the memory 730 can include computer-readable media in the form of volatile memory, such as random access memory (RAM), and/or non-volatile memory, such as read-only memory (ROM).

As is illustrated in FIG. 7, the memory 730 can include functionality instructions storage 734 and functionality information storage 738. The functionality instructions storage 734 can include computer-accessible instructions that, in response to execution (by at least one of the processor(s) 714, for example), can implement one or more of the functionalities for generation of manufacturing schedules that integrate maintenance strategies, in accordance with this disclosure. The computer-accessible instructions can embody or can comprise one or more software components illustrated as schedule generator modules 736.

In one scenario, execution of at least one component of the schedule generator modules 736 can implement one or more of the techniques disclosed herein, such as the example method 600. For instance, such execution can cause a processor (e.g., one of the processor(s) 714) that executes the at least one component to carry out a disclosed example method or another technique of this disclosure.

It is noted that, in one aspect, a processor of the processor(s) 714 that executes at least one of the schedule generator modules 736 can retrieve information from or retain information in one or more memory elements 740 in the functionality information storage 738 in order to operate in accordance with the functionality programmed or otherwise configured by the schedule generator modules 736. The one or more memory elements 740 can be generically referred to as schedule generator information 740. Such information can include at least one of code instructions, information structures, or the like. For instance, at least a portion of such information structures can be indicative or otherwise representative of optimization parameters (e.g., optimization parameters 180); schedules (e.g., schedule(s) 190); plant bills of process (e.g., plant BOP 170 ); product bills of process (e.g., product BOP 160); a combination thereof; and the like, in accordance with aspects described herein.

In some embodiments, one or more of the schedule generator modules 736 can embody or can constitute, for example, the modules included in the schedule generator system 130; namely, configuration module 140, and/or optimization module 150 in accordance with aspects of this disclosure.

At least one of the one or more interfaces 750 (e.g., application programming interface(s)) can permit or otherwise facilitate communication of information between two or more modules within the functionality instructions storage 734. The information that is communicated by the at least one interface can result from implementation of one or more operations in a method of the disclosure. In some embodiments, one or more of the functionality instructions storage 734 and the functionality information storage 738 can be embodied in or can comprise removable/non-removable, and/or volatile/non-volatile computer storage media.

At least a portion of at least one of the schedule generator modules 736 or the timer series generation information 740 can program or otherwise configure one or more of the processors 714 to operate at least in accordance with the functionality disclosed herein to generate a manufacturing schedule that integrates a maintenance strategy (or another type of maintenance planning). One or more of the processor(s) 714 can execute at least one of the schedule generator modules 736 and leverage at least a portion of the information in the functionality information storage 738 in order to provide management of calls from unknown callers in accordance with one or more aspects described herein.

It is noted that, in some embodiments, the functionality instructions storage 734 can embody or can comprise a computer-readable non-transitory storage medium having computer-accessible instructions that, in response to execution, cause at least one processor (e.g., one or more of the processor(s) 714) to perform a group of operations comprising the operations or blocks described in connection with the example method 1200 and other techniques disclosed herein.

The memory 730 also can include computer-accessible instructions and information (e.g., data, metadata, and/or programming code instructions) that permit or otherwise facilitate the operation and/or administration (e.g., upgrades, software installation, any other configuration, or the like) of the computing device 710. Accordingly, as is illustrated, the memory 730 includes a memory element 742 (labeled operating system (OS) instructions 742) that contains one or more program modules that embody or include one or more operating systems, such as Windows operating system, Unix, Linux, Symbian, Android, Chromium, and substantially any OS suitable for mobile computing devices or tethered computing devices. In one aspect, the operational and/or architectural complexity of the computing device 710 can dictate a suitable OS.

The memory 730 further includes a system information storage 746 having data, metadata, and/or programming code (e.g., firmware) that can permit or otherwise can facilitate the operation and/or administration of the computing device 710. Elements of the OS instructions 742 and the system information storage 746 can be accessible or can be operated on by at least one of the processor(s) 714.

While the functionality instructions storage 734 and other executable program components (such as the OS instructions 742) are illustrated herein as discrete blocks, such software components can reside at various times in different memory components of the computing device 710 and can be executed by at least one of the processor(s) 714. In certain scenarios, an implementation of the schedule generator modules 736 can be retained on or transmitted across some form of computer-readable media.

As is illustrated in FIG. 7, in some instances, the computing device 710 can operate in a networked environment by utilizing connections to one or more remote computing devices 770. As an illustration, a remote computing device can be a personal computer, a portable computer, a server, a router, a network computer, a peer device or other common network node, and so on. As described herein, connections (physical and/or logical) between the computing device 710 and a computing device of the one or more remote computing devices 770 can be made via one or more networks 780, and various communication links (wireless or wireline). The network(s) 780 can include several types of network elements, including base stations; router devices; switch devices; server devices; aggregator devices; bus architectures; a combination of the foregoing; or the like. The network elements can be assembled to form a local area network (LAN), a metropolitan area network (MAN), a wide area network (WAN), and/or other networks (wireless or wired) having different footprints.

In addition, as is illustrated the communication links can be assembled in a first group of communication links 774 and a second group of communication links 772. Each one of the communication links in both groups can include one of an upstream link (or uplink (UL)) or a downstream link (or downlink (DL)). Each one of the UL and the DL can be embodied in or can include wireless links (e.g., deep-space wireless links and/or terrestrial wireless links), wireline links (e.g., optic-fiber lines, coaxial cables, and/or twisted-pair lines), or a combination thereof.

The first group of communication links 774 and the second group of communication links 772 can permit or otherwise facilitate the exchange of information (e.g., data, metadata, and/or signaling) between at least one of the computing device(s) 770 and the computing device 710. To that end, one or more links of the first group of communication links 774, one or more links of the second group of communication links 774, and at least one of the network(s) 780 can form a communication pathway between the communication device 710 and at least one of the computing device(s) 770.

In one or more embodiments, one or more of the disclosed methods can be practiced in distributed computing environments, such as grid-based environments, where tasks can be performed by remote processing devices (computing device(s) 770) that are functionally coupled (e.g., communicatively linked or otherwise coupled) through at least one of network(s) 710. In a distributed computing environment, in one aspect, one or more software components (such as program modules) can be located within both a local computing device (e.g., computing device 710) and at least one remote computing device.

Various embodiments of the disclosure may take the form of an entirely or partially hardware embodiment, an entirely or partially software embodiment, or a combination of software and hardware. Further, as described herein, various embodiments of the disclosure (e.g., systems and methods) may take the form of a computer program product including a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can be embodied in or can include ROM; RAM; magnetic disk storage media; optical storage media; flash memory, etc.

At least some of the embodiments of the operational environments, systems, devices, and techniques are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or technique put forth herein be construed as requiring that its acts or steps be performed in a specific order. Accordingly, where a process or a method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of embodiments described in the specification or annexed drawings, or the like.

As used in this application, the terms “environment,” “system,” “module,” “component,” “architecture,” “interface,” and the like refer to a computer-related entity or an entity related to an operational apparatus with one or more defined functionalities. The terms “environment,” “system,” “module,” “component,” “architecture,” “interface,” and “unit,” can be utilized interchangeably and can be generically referred to functional elements. Such entities may be either hardware, a combination of hardware and software, software, or software in execution. As an example, a module can be embodied in a process running on a processor, a processor, an object, an executable portion of software, a thread of execution, a program, and/or a computing device. As another example, both a software application executing on a computing device and the computing device can embody a module. As yet another example, one or more modules may reside within a process and/or thread of execution. A module may be localized on one computing device or distributed between two or more computing devices. As is disclosed herein, a module can execute from various computer-readable non-transitory storage media having various data structures stored thereon. Modules can communicate via local and/or remote processes in accordance, for example, with a signal (either analogic or digital) having one or more data packets (e.g., data from one component interacting with another component in a local system, distributed system, and/or across a network such as a wide area network with other systems via the signal).

As yet another example, a module can be embodied in or can include an apparatus with a defined functionality provided by mechanical parts operated by electric or electronic circuitry that is controlled by a software application or firmware application executed by a processor. Such a processor can be internal or external to the apparatus and can execute at least part of the software or firmware application. Still in another example, a module can be embodied in or can include an apparatus that provides defined functionality through electronic components without mechanical parts. The electronic components can include a processor to execute software or firmware that permits or otherwise facilitates, at least in part, the functionality of the electronic components.

In some embodiments, modules can communicate via local and/or remote processes in accordance, for example, with a signal (either analog or digital) having one or more data packets (e.g., data from one component interacting with another component in a local system, distributed system, and/or across a network such as a wide area network with other systems via the signal). In addition, or in other embodiments, modules can communicate or otherwise be coupled via thermal, mechanical, electrical, and/or electromechanical coupling mechanisms (such as conduits, connectors, combinations thereof, or the like). An interface can include input/output (I/O) components as well as associated processors, applications, and/or other programming components.

As is utilized in this disclosure, the term “processor” can refer to any type of processing circuitry or device. A processor can be implemented as a combination of processing circuitry or computing processing units (such as CPUs, GPUs, or a combination of both). Therefore, for the sake of illustration, a processor can refer to a single-core processor; a single processor with software multithread execution capability; a multi-core processor; a multi-core processor with software multithread execution capability; a multi-core processor with hardware multithread technology; a parallel processing (or computing) platform; and parallel computing platforms with distributed shared memory.

Additionally, or as another example, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed or otherwise configured (e.g., manufactured) to perform the functions described herein.

In some embodiments, processors can utilize nanoscale architectures. in order to optimize space usage or enhance the performance of systems, devices, or other electronic equipment in accordance with this disclosure. For instance, a processor can include molecular transistors and/or quantum-dot based transistors, switches, and gates,

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

Memory components or memory devices disclosed herein can be embodied in either volatile memory or non-volatile memory or can include both volatile and non-volatile memory. In addition, the memory components or memory devices can be removable or non-removable, and/or internal or external to a computing device or component. Examples of various types of non-transitory storage media can include hard-disc drives, zip drives, CD-ROMs, digital versatile disks (DVDs) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory devices or memories of the operational or computational environments described herein are intended to include one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The flowchart and block diagrams in the Figures illustrate the architecture, functionality, and operation of possible implementations of examples of systems, methods, and computer program products according to various embodiments of the present disclosure. In this regard, each block in the flowchart or block diagrams may represent a module, segment, or portion of instructions, which includes one or more machine- or computer-executable instructions for implementing the specified operations. It is noted that each block of the block diagrams and/or flowchart illustration, and combinations of blocks in the block diagrams and/or flowchart illustration, can be implemented by special purpose hardware-based systems that perform the specified functions or operations or carry out combinations of special purpose hardware and computer instructions.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer-readable non-transitory storage medium within the respective computing/processing device.

What has been described herein in the present specification and annexed drawings includes examples of systems, devices, techniques, and computer program products that, individually or in combination, permit generating manufacturing schedules that integrate maintenance strategies. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. A computer-implemented method, comprising:
receiving first data indicative of a group of manufacturing parameters corresponding to a process for manufacturing a product, the process comprising multiple operations executed by respective machines;
configuring second data indicative of a group of processing constraints corresponding to execution of the multiple operations;
configuring third data indicative of a group of maintenance parameters corresponding to respective maintenance tasks for the respective machines;
configuring fourth data indicative of a group of maintenance constraints corresponding to performance of the maintenance tasks; and
generating, using at least the group of processing constraints and the group of maintenance constraints, a schedule for the machines to execute the process for manufacturing the product.

2. The computer-implemented method of claim 1, wherein the generating comprises solving an optimization problem with respect to a makespan of the product subject to the group of processing constraints and the group of maintenance constraints.

3. The computer-implemented method of claim 2, wherein the solving the optimization problem comprises:
configuring a first group of binary parameters for respective ones of the multiple operations;
configuring a second group of binary parameters for the respective ones of the multiple operations;
updating iteratively the first group of binary parameters and the second group of binary parameters subject at least to at least the group of processing constraints and the group of maintenance constraints until a converge criterion is satisfied, resulting in a first group of optimal binary parameters and a second group of optimal binary parameters; and
generating the schedule using at least the first group of optimal binary parameters and the second group of optimal parameters.

4. The computer-implemented method of claim 3, wherein the updating comprises performing a branch-and-bound process.

5. The computer-implemented method of claim 4, wherein the group of processing constraints comprises a first processing constraint based at least on a first processing time of the processing times and the quality assurance parameter, the first processing time corresponding to a first operation of the multiple operations, and wherein the first processing constraint requires that the first operation is completed before a second operation consecutive to the first operation is initiated.

6. The computer-implemented method of claim 1, wherein the group of manufacturing parameters comprises processing time intervals corresponding to completion of respective ones of the multiple operations.

7. The computer-implemented method of claim 1, wherein the group of manufacturing parameters comprises a reiteration parameter indicative of a number of times a first operation of the operations is performed.

8. The computer-implemented method of claim 1, wherein the group of maintenance constraints comprises a first maintenance constraint based at least on a defined period of maintenance events for a first machine of the machines and a decommission time interval of the first machine.

9. A system, comprising:
at least one memory device having stored therein computer-executable instructions; and
at least one processor configured to access the at least one memory device and further configured to execute the computer-executable instructions to:
receive first data indicative of a group of manufacturing parameters corresponding to a process for manufacturing a product, the process comprising multiple operations executed by respective machines;
configure second data indicative of a group of processing constraints corresponding to execution of the multiple operations;
configure third data indicative of a group of maintenance parameters corresponding to respective maintenance tasks for the respective machines;
configure fourth data indicative of a group of maintenance constraints corresponding to performance of the maintenance tasks; and
generate, using at least the group of processing constraints and the group of maintenance constraints, a schedule for the machines to execute the process for manufacturing the product.

10. The system of claim 9, wherein to generate the schedule, the at least one processor being further configured to execute the computer-executable instructions to solve an optimization problem with respect to a makespan of the product subject to the group of processing constraints and the group of maintenance constraints.

11. The system of claim 10, wherein to solve the optimization problem, the at least one processor being further configured to execute the computer-executable instructions to:
configure a first group of binary parameters for respective ones of the multiple operations;
configure a second group of binary parameters for the respective ones of the multiple operations;
update iteratively the first group of binary parameters and the second group of binary parameters subject at least to at least the group of processing constraints and the group of maintenance constraints until a converge criterion is satisfied, resulting in a first group of optimal binary parameters and a second group of optimal binary parameters; and
generate the schedule using at least the first group of optimal binary parameters and the second group of optimal parameters.

12. The system of claim 11, wherein to update iteratively the first group of binary parameters and the second group of binary parameters, the at least one processor being further configured to execute the computer-executable instructions to perform a branch-and-bound process.

13. The system of claim 9, wherein the group of manufacturing parameters comprises processing time intervals corresponding to completion of respective ones of the multiple operations.

14. The system of claim 9, wherein the group of maintenance constraints comprises a first maintenance constraint based at least on a defined period of maintenance events for a first machine of the machines and a decommission time interval of the first machine.

15. The system of claim 9, wherein the group of manufacturing parameters comprises a reiteration parameter indicative of a number of times a first operation of the operations is performed.

16. The system of claim 15, wherein the group of processing constraints comprises a first processing constraint based at least on a first processing time interval of the processing time intervals and the reiteration parameter, the first processing time interval corresponding to a first operation of the multiple operations, and wherein the first processing constraint requires that the first operation is completed before a second operation consecutive to the first operation is initiated.

17. A computer program product comprising at least one non-transitory storage medium readable by at least one processing circuit, the non-transitory storage medium having encoded thereon instructions executable by the at least one processing circuit to perform or facilitate operations comprising:
receiving first data indicative of a group of manufacturing parameters corresponding to a process for manufacturing a product, the process comprising multiple operations executed by respective machines;
configuring second data indicative of a group of processing constraints corresponding to execution of the multiple operations;
configuring third data indicative of a group of maintenance parameters corresponding to respective maintenance tasks for the respective machines;
configuring fourth data indicative of a group of maintenance constraints corresponding to performance of the maintenance tasks; and
generating, using at least the group of processing constraints and the group of maintenance constraints, a schedule for the machines to execute the process for manufacturing the product.

18. The computer program product of claim 17, wherein the generating comprises solving an optimization problem with respect to a makespan of the product subject to the group of processing constraints and the group of maintenance constraints.

19. The computer program product of claim 18, wherein the solving the optimization problem comprises:
configuring a first group of binary parameters for respective ones of the multiple operations;
configuring a second group of binary parameters for the respective ones of the multiple operations;
updating iteratively the first group of binary parameters and the second group of binary parameters subject at least to at least the group of processing constraints and the group of maintenance constraints until a converge criterion is satisfied, resulting in a first group of optimal binary parameters and a second group of optimal binary parameters; and
generating the schedule using at least the first group of optimal binary parameters and the second group of optimal parameters.

20. The computer program product of claim 19, wherein the updating comprises performing a branch-and-bound process.
